(19) United States
(12) Patent Application Publication
(10) Pub. No.: US 2014/0283060 A1
(43) Pub. Date: Sep. 18, 2014

(54) MITIGATING VULNERABILITIES ASSOCIATED WITH RETURN-ORIENTED PROGRAMMING

(71) Applicant: ORACLE INTERNATIONAL CORPORATION, Redwood City, CA (US)

(72) Inventor: Derek L. Beatty, Austin, TX (US)

(73) Assignee: Oracle International Corporation, Redwood City, CA (US)

(21) Appl. No.: 13/850,066

(22) Filed: Mar. 25, 2013

Related U.S. Application Data
(60) Provisional application No. 61/793,533, filed on Mar. 15, 2013.

(51) Int. Cl. G06F 21/56

(52) U.S. Cl. CPC G06F 21/56
USPC 726/23

(57) ABSTRACT

The disclosed embodiments provide a system that operates a processor in a computer system. During operation, the system identifies one or more return sites associated with a call instruction of a software program. Next, the system restricts execution of a return from the call instruction by the processor to the one or more return sites.

### RELATED APPLICATION

This application claims priority under 35 U.S.C. §119 to U.S. Provisional Application No. 61/793,533, entitled “Mitigating Vulnerabilities Associated with Return-Oriented Programming,” by Derek L. Beatty, filed 15 Mar. 2013 (Atty. Docket No.: ORA13-0027PSP), the contents of which are herein incorporated by reference in their entirety.

### BACKGROUND

1. Field

The disclosed embodiments relate to computer security. More specifically, the disclosed embodiments relate to techniques for mitigating vulnerabilities associated with return-oriented programming.

2. Related Art

As malware (e.g., malicious software) becomes more prevalent, securing computer systems against malware-based attacks is increasingly important. One principle of security is “defense in depth,” or multiple layers of security that an attacker must penetrate for a successful attack. For example, a computer system may reduce its vulnerability to a code-injection attack by implementing a Harvard architecture that includes physically separate storage and signal pathways for instructions and data.

However, attackers may use a combination of buffer overruns and return-oriented programming to successfully exploit computer systems, including those with true Harvard architectures: attacks have been demonstrated against voting machines containing hardware that prevents execution from random-access memory (RAM). During a return-oriented programming attack, an attacker may determine that a software program has a buffer overrun by feeding the software program malformed and/or randomized input. By analyzing crashes of the software program from the input data, the attacker may acquire the ability to overrun the buffer at will. Moreover, if the buffer is on the call stack, the attacker may construct an attack by overwriting return addresses on the call stack.

Because the attack does not rely on the ability to overwrite instructions, segregating executable segments from writable segments does not defend against the attack. Instead, the attack may overwrite return addresses on the call stack, causing the processor to return to a series of locations that contain legitimate code but are not legitimate entry points for execution. For example, a subroutine may check its arguments for safety, and then perform a potentially dangerous operation. If the attacker can arrange for a return to the address following the safety checks, he/she can cause an unchecked operation. The attacker may then overwrite multiple stack frames to generate a series of malicious operations that compromises the software program and/or computer system on which the software program executes.

Consequently, computer security may be improved by mitigating vulnerabilities associated with return-oriented programming.

### SUMMARY

The disclosed embodiments provide a system that operates a processor in a computer system. During operation, the system identifies one or more return sites associated with a call instruction of a software program. Next, the system restricts execution of a return from the call instruction by the processor to the one or more return sites.

In some embodiments, identifying the one or more return sites associated with the call instruction involves at least one of:
(i) marking the one or more return sites;
(ii) determining one or more addresses of the one or more return sites; and
(iii) securely storing the one or more addresses.

In some embodiments, the one or more addresses are securely stored in at least one of a buffer and a stack.

In some embodiments, restricting execution of the return from the call by the processor to the one or more return sites involves enabling execution of the return by the processor if a return address of the return matches a return site from the one or more return sites, and trapping the return if the return address does not match the return site.

In some embodiments, the one or more return sites include an instruction immediately following the call instruction.

In some embodiments, the one or more return sites further include a set of instructions immediately following a set of call instructions in the software program.

In some embodiments, the one or more return sites include a return site for a nonstandard call instruction.

In some embodiments, the one or more return sites are identified during at least one of:
(i) compilation of the software program;
(ii) dynamic linking of the software program; and
(iii) runtime of the software program.

### BRIEF DESCRIPTION OF THE FIGURES

FIG. 1 shows a computer system in accordance with the disclosed embodiments.

FIG. 2 shows a system for operating a processor in a computer system in accordance with the disclosed embodiments.

FIG. 3 shows a flowchart illustrating the process of operating a processor in a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method and system for operating a processor in a computer system. As shown in FIG. 1, a computer system 102 includes a processor 104, memory 110, and/or other components found in electronic computing devices. Processor 104 may support parallel processing and/or multi-threaded operation with other processors in computer system 102. Computer system 102 may also include input/output (I/O) devices (not shown) such as a keyboard, mouse, touchscreen, display, microphone, speakers, and/or other I/O devices now known or later developed.

Computer system 102 may be an electronic device that provides one or more services or functions to a user. For example, computer system 102 may operate as a mobile phone, tablet computer, personal computer, laptop computer, global positioning system (GPS) receiver, portable media player, personal digital assistant (PDA), server, and/or workstation.

In addition, computer system 102 may include an operating system (not shown) that coordinates the use of hardware and software resources on computer system 102, as well as one or more software programs and/or applications that perform specialized tasks for the user. For example, computer system 102 may include applications such as an email client, an address book, a document editor, a tax preparation application, a web browser, and/or a media player. To perform tasks for the user, the software programs may obtain the use of hardware resources (e.g., processor 104, memory 110, I/O components, wireless transmitter, etc.) on computer system 102 from the operating system, as well as interact with the user through a hardware and/or software framework provided by the operating system.

In addition, computer system 102 may include functionality to execute multiple software programs. Each software program may be transformed into an executable form by a compiler 126, which is then loaded and/or linked to one or more shared libraries by a dynamic linker 122 to enable execution of the software program within a runtime environment 124.

The software program may then be executed using a process 106-108 and/or one or more threads on processor 104, with management of multiple executing processes and/or threads performed by runtime environment 124 and/or the operating system on computer system 102. For example, each process 106-108 may represent an instance of a software program running on computer system 102. The process may also include one or more threads that are scheduled and managed across processor 104 and/or other processors of computer system 102 by the operating system.

Each process 106-108 may also include an address space in memory 110 that enables execution of the corresponding software program. Within the address space, the process may utilize a set of registers 112, a code segment 114, a data segment 116, a stack segment 118, and/or a heap 120 to implement the functionality of the software program. For example, one or more threads within the process may execute code for the software program from code segment 114 on registers 112 provided by processor 104. Each thread may also have access to global variables in data segment 116 and objects in heap 120 and be associated with a separate call stack in stack segment 118.

Those skilled in the art will appreciate that computer system 102 may be vulnerable to attacks that utilize return-oriented programming, even if processor 104 implements a Harvard architecture that separates code segment 114 and data segment 116 into separate memory 110 systems. For example, an attacker may use buffer overruns to overwrite a call stack in stack segment 118, causing the corresponding software program to return to locations that are not legitimate entry points for execution. The attacker may then use the overwritten stack frames to generate a series of malicious operations on processor 104 and compromise computer system 102.

In one or more embodiments, computer system 102 includes functionality to mitigate vulnerabilities associated with return-oriented programming. As discussed in further detail below, computer system 102 may identify one or more return sites associated with each call instruction of the software program and restrict execution of a return from the call instruction by processor 104 to the identified return site(s). The return site(s) may include an instruction immediately following the call instruction, a set of instructions immediately following a set of call instructions in the software program, and/or a return site for a nonstandard call instruction. By limiting execution of returns to the identified return site(s), computer system 102 may reduce the attack surface area of the software program and, in turn, the likelihood of success of a return-oriented programming attack.

FIG. 2 shows a system for operating processor 104 in a computer system (e.g., computer system 102 of FIG. 1) in accordance with the disclosed embodiments. As mentioned above, processor 104 may execute a software program 202 as a process and/or one or more threads within the process. Furthermore, control of software program 202 may be passed among a set of subroutines by a set of call instructions (e.g., call instruction 1 208, call instruction x 210) to the subroutines and a set of return sites (e.g., return site 1 212, return site y 214) to which the call instructions may return after the called subroutines have finished executing.

To reduce the vulnerability of the computer system to return-oriented programming attacks, an identification mechanism 204 associated with processor 104 may identify, for each call instruction (e.g., call instruction 1 208, call instruction x 210) to be executed by processor 104, one or more return sites (e.g., return site 1 212, return site y 214) associated with the call instruction. Next, an execution mechanism 206 in processor 104 may restrict execution of a return 216 from the call instruction by processor 104 to the identified return site(s).

The identified return site(s) may represent legitimate return sites for call instructions in software program 202. For example, each call instruction may be associated with a legitimate return site that is located directly below the call instruction. After execution of the subroutine invoked by the call instruction completes, processor 104 may return 216 to the instruction following the call instruction to continue execution of software program 202. On the other hand, the call instruction may be a nonstandard call instruction that includes a legitimate return 216 to an address other than the one following the call instruction. Both types of return sites may be included in the identified return site(s) to enable safe, correct execution of software program 202.

In addition, a number of techniques may be used to identify the return site(s) and/or restrict execution of returns (e.g., return 216) from call instructions to the return site(s). For example, identification mechanism 204 may mark legitimate return addresses associated with call instructions in software program 202 by setting one or more bits and/or flags at each return address and/or the instruction at the return address. Alternatively, identification mechanism 204 may record the return addresses in hardware and provide the recorded addresses to processor 104 and/or execution mechanism 206. Execution mechanism 206 may then restrict returns from the call instructions to the legitimate return addresses by modifying the return instruction so that the return instruction is executed only if the return address of the return instruction corresponds to a marked and/or recorded return address. If the return address is not marked and/or recorded, execution mechanism 206 may trap the return instruction and prevent the return instruction from transferring control to a non-legitimate entry point of execution in software program 202.

The operation of identification mechanism 204 and/or execution mechanism 206 may also be simplified in the absence of nonstandard call instructions in software program 202. For example, the location preceding the return address of each return (e.g., return 216) may be examined for a call instruction (e.g., the call instruction from which to return). If the location contains a call instruction, the return is executed. If the location does not contain a call instruction, the return is trapped.

The functionality of identification mechanism 204 may also be implemented at various stages in the development and/or execution of software program 202. First, identification mechanism 204 may be associated with a compiler (e.g., compiler 126 of FIG. 1) that marks, stores, and/or otherwise identifies instructions corresponding to legitimate return sites of call instructions in software program 202 during compilation of software program 202. As a result, execution of each return from a call instruction may be restricted to the set of legitimate return sites in software program 202 instead of all executable instructions in the address space of software program 202. For example, identification mechanism 204 may identify 5% of instructions in software program 202 as legitimate return sites, thus reducing the addresses that can be used by a return-oriented programming attack by 95%.

Second, identification mechanism 204 may be associated with a dynamic linker (e.g., dynamic linker 122 of FIG. 1) that identifies specific memory addresses of the legitimate return sites during loading and/or dynamic linking of software program 202. As with identification of the addresses during compilation of software program 202, the addresses may be securely stored, marked, and/or otherwise provided to execution mechanism 206 so that returns from the call instructions are limited to the addresses.

Finally, identification mechanism 204 may be associated with a runtime environment (e.g., runtime environment 124 of FIG. 1) that obtains a call instruction to be executed, identifies the address of a specific legitimate return site for the call instruction, and securely stores the address for subsequent use by execution mechanism 206 in executing a return from the call instruction. To manage nested and/or recursive call instructions, identification mechanism 204 may store addresses associated with the call instructions in a secure hardware buffer and/or stack.

For example, identification mechanism 204 may store the addresses in the buffer and/or stack so that the return site of the most recent call instruction in a series of nested and/or recursive call instructions is represented by the return address at the top of the buffer and/or stack. During execution of a return from the call instruction, execution mechanism 206 may obtain the address of the corresponding return site from the top of the buffer and/or stack and compare the stored address with the return address of the return. Execution mechanism 206 may permit execution of the return if the two addresses match and trap the return if the two addresses do not match. If the return successfully executes, execution mechanism 206 may pop the stored address from the top of the buffer and/or stack and proceed to the next stored address for execution of the return from the previous call instruction in the series of nested and/or recursive call instructions.

By limiting execution of returns from call instructions to legitimate return sites within software program 202, the system of FIG. 2 may limit an attacker's ability to perform malicious operations through a series of non-legitimate returns from the call instructions. Consequently, identification mechanism 204 and execution mechanism 206 may reduce the vulnerability of software program 202 to a return-oriented programming attack.

Moreover, the operation of identification mechanism 204 and execution mechanism 206 may be adjusted to facilitate compatibility with different software programs, security policies, and/or environments. For example, restricted execution of returns to the identified return sites may be enabled to maintain a high level of security in the computer system. In turn, all software programs executing in the computer system may be written and/or compiled to accommodate the modified execution of the returns by processor 104 and/or execution mechanism 206. On the other hand, the functionality of identification mechanism 204 and/or execution mechanism 206 may be disabled to enable execution of legacy software programs and/or optimize for performance during execution of software programs on processor 104.

FIG. 3 shows a flowchart illustrating the process of operating a processor in a computer system in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, one or more return sites associated with a call instruction of a software program are identified (operation 302). For example, the return site(s) may be identified by marking the return site(s), determining one or more addresses of the return site(s), and/or securely storing the address(es) (e.g., in a buffer and/or stack). The return sites may include an instruction immediately following the call instruction, a set of instructions immediately following a set of call instructions in the software program, and/or a return site of a nonstandard call instruction. The return sites may be identified during compilation, dynamic linking, and/or runtime of the software program.

Next, execution of a return from the call instruction by the processor is restricted to the identified return site(s). In particular, a return address of the return is compared to the identified return site(s) to determine if the return address matches one of the return sites (operation 304). If the return address matches the return site, execution of the return by the processor is enabled (operation 306), and execution of the software program may continue. If the return address does not match the return site, the return is trapped (operation 308) to prevent a return to a non-legitimate entry point of execution in the software program.

Execution of returns from call instructions may continue to be restricted (operation 310). For example, returns from call instructions may be restricted during runtime of the software program and/or while restricted execution of returns is enabled in the computer system. If execution of the returns is to be restricted, return sites associated with each call instruction to be executed in the software program are identified (operation 302), and execution of a return from the call instruction is restricted to the return sites (operations 304-308). Such restricted execution of returns may continue (operation 310) until the software program has completed execution and/or restricted execution of the returns is disabled for the software program and/or computer system.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for operating a processor in a computer system, comprising:
identifying one or more return sites associated with a call instruction of a software program; and
restricting execution of a return from the call instruction by the processor to the one or more return sites.

2. The method of claim 1, wherein identifying the one or more return sites associated with the call instruction involves at least one of:
marking the one or more return sites;
determining one or more addresses of the one or more return sites; and
securely storing the one or more addresses.

3. The method of claim 2, wherein the one or more addresses are securely stored in at least one of:
a buffer; and
a stack.

4. The method of claim 1, wherein restricting execution of the return from the call by the processor to the one or more return sites involves:
if a return address of the return matches a return site from the one or more return sites, enabling execution of the return by the processor; and
if the return address does not match the return site, trapping the return.

5. The method of claim 1, wherein the one or more return sites comprise an instruction immediately following the call instruction.

6. The method of claim 5, wherein the one or more return sites further comprise a set of instructions immediately following a set of call instructions in the software program.

7. The method of claim 1, wherein the one or more return sites comprise a return site for a nonstandard call instruction.

8. The method of claim 1, wherein the one or more return sites are identified during at least one of:
compilation of the software program;
dynamic linking of the software program; and
runtime of the software program.

9. A system for operating a processor in a computer system, comprising:
an identification mechanism configured to identify one or more return sites associated with a call instruction of a software program; and
an execution mechanism within the processor, wherein the execution mechanism is configured to restrict execution of a return from the call instruction by the processor to the one or more return sites.

10. The system of claim 9, wherein identifying the one or more return sites associated with the call instruction involves at least one of:
marking the one or more return sites;
determining one or more addresses of the one or more return sites; and
securely storing the one or more addresses.

11. The system of claim 9, wherein restricting execution of the return from the call by the processor to the one or more return sites involves:
if a return address of the return matches a return site from the one or more return sites, enabling execution of the return by the processor; and
if the return address does not match the return site, trapping the return.

12. The system of claim 9, wherein the one or more return sites comprise an instruction immediately following the call instruction.

13. The system of claim 12, wherein the one or more return sites further comprise a set of instructions immediately following a set of call instructions in the software program.

14. The system of claim 9, wherein the one or more return sites comprise a return site for a nonstandard call instruction.

15. The system of claim 9, wherein the one or more return sites are identified during at least one of:
compilation of the software program;
dynamic linking of the software program; and
runtime of the software program.

16. A computer-readable storage medium storing instructions that when executed by a computer cause the computer to perform a method for operating a processor in a computer system, the method comprising:
identifying one or more return sites associated with a call instruction of a software program; and
restricting execution of a return from the call instruction by the processor to the one or more return sites.

17. The computer-readable storage medium of claim 16, wherein identifying the one or more return sites associated the call instruction involves at least one of:
marking the one or more return sites;
determining one or more addresses of the one or more return sites; and
securely storing the one or more addresses.

18. The computer-readable storage medium of claim 16, wherein restricting execution of the return from the call by the processor to the one or more return sites involves:
if a return address of the return matches a return site from the one or more return sites, enabling execution of the return by the processor; and
if the return address does not match the return site, trapping the return.

19. The computer-readable storage medium of claim 16, wherein the one or more return sites comprise an instruction immediately following the call instruction.

20. The computer-readable storage medium of claim 19, wherein the one or more return sites further comprise at least one of:
a set of instructions immediately following a set of call instructions in the software program; and
a return site for a nonstandard call instruction.
